(19) United States
(12) Patent Application Publication
(10) Pub. No.: US 2024/0184171 A1
(43) Pub. Date: Jun. 6, 2024

(54) ELECTRONIC DEVICE

(71) Applicant: InnoLux Corporation, Miao-Li County (TW)

(72) Inventors: Yung-Fu TSAI, Miao-Li County (TW); Chin-Che HU, Miao-Li County (TW)

(21) Appl. No.: 18/500,336

(22) Filed: Nov. 2, 2023

(30) Foreign Application Priority Data
Dec. 2, 2022 (CN) 202211541544.X

(51) Int. Cl. G02F 1/1347; F21V 8/00; G02F 1/1335

(52) U.S. Cl. CPC G02F 1/1347; G02B 6/0053; G02F 1/133504; G02F 1/133531; G02F 2202/28

(57) ABSTRACT

An electronic device is provided. The electronic device includes a backlight module, a first liquid-crystal module and a second liquid-crystal module. The first liquid-crystal module is disposed on the backlight module. The second liquid-crystal module is disposed on the first liquid-crystal module. The first liquid-crystal module includes a first liquid-crystal layer, a first polarizer, a second polarizer and a first compensation film. The first polarizer is adjacent to the backlight module compared to the second polarizer. The first liquid-crystal layer is disposed between the first polarizer and the second polarizer and has a first alignment direction. The first compensation film is disposed between the first polarizer or the second polarizer and the first liquid-crystal layer. The first alignment direction is parallel to the transmission axis of the first polarizer or second polarizer.

### CROSS REFERENCE TO RELATED APPLICATIONS

This application claims priority of China Patent Application No. 202211541544.X, filed on Dec. 2, 2022, the entirety of which is incorporated by reference herein.

### BACKGROUND

### Technical Field

The present disclosure relates to an electronic device, and in particular it relates to an electronic device with dual cells.

### Description of the Related Art

Traditional dual-cell displays can only improve the degree of contrast, but cannot take into account the horizontal brightness and viewing angle, and fails to meet the requirements of high brightness and wide viewing angle at the same time.

### SUMMARY

In accordance with one embodiment of the present disclosure, an electronic device is provided. The electronic device includes a backlight module, a first liquid-crystal module and a second liquid-crystal module. The first liquid-crystal module is disposed on the backlight module. The second liquid-crystal module is disposed on the first liquid-crystal module. The first liquid-crystal module includes a first liquid-crystal layer, a first polarizer, a second polarizer and a first compensation film. The first polarizer is adjacent to the backlight module compared to the second polarizer. The first liquid-crystal layer is disposed between the first polarizer and the second polarizer. The first liquid-crystal layer has a first alignment direction. The first compensation film is disposed between the first liquid-crystal layer and one of the first polarizer and the second polarizer. The first alignment direction is parallel to the transmission axis of the one of the first polarizer and the second polarizer.

A detailed description is given in the following embodiments with reference to the accompanying drawings.

### BRIEF DESCRIPTION OF THE DRAWINGS

The disclosure can be more fully understood from the following detailed description when read with the accompanying figures. It is worth noting that in accordance with standard practice in the industry, various features are not drawn to scale. In fact, the dimensions of the various features may be arbitrarily increased or reduced for clarity of discussion.

FIG. 1 shows a cross-sectional view of an electronic device in accordance with one embodiment of the present disclosure;

FIG. 2A shows a pixel pattern of an electronic device in accordance with one embodiment of the present disclosure;

FIG. 2B shows a pixel pattern of an electronic device in accordance with one embodiment of the present disclosure;

FIG. 3 shows a layer-by-layer stack diagram of an electronic device in accordance with one embodiment of the present disclosure;

FIG. 4 shows a cross-sectional view of an electronic device in accordance with one embodiment of the present disclosure;

FIG. 5 shows a layer-by-layer stack diagram of an electronic device in accordance with one embodiment of the present disclosure;

FIG. 6 shows a cross-sectional view of an electronic device in accordance with one embodiment of the present disclosure;

FIG. 7 shows a layer-by-layer stack diagram of an electronic device in accordance with one embodiment of the present disclosure;

FIG. 8 shows a cross-sectional view of an electronic device in accordance with one embodiment of the present disclosure; and

FIG. 9 shows a layer-by-layer stack diagram of an electronic device in accordance with one embodiment of the present disclosure.

### DETAILED DESCRIPTION

Various embodiments or examples are provided in the following description to implement different features of the present disclosure. The elements and arrangement described in the following specific examples are merely provided for introducing the present disclosure and serve as examples without limiting the scope of the present disclosure. For example, when a first component is referred to as “on a second component”, it may directly contact the second component, or there may be other components in between, and the first component and the second component do not come in direct contact with one another.

It should be understood that additional operations may be provided before, during, and/or after the described method. In accordance with some embodiments, some of the stages (or steps) described below may be replaced or omitted.

In this specification, spatial terms may be used, such as “below”, “lower”, “above”, “higher” and similar terms, for briefly describing the relationship between an element relative to another element in the figures. Besides the directions illustrated in the figures, the devices may be used or operated in different directions. When the device is turned to different directions (such as rotated 45 degrees or other directions), the spatially related adjectives used in it will also be interpreted according to the turned position. In some embodiments of the present disclosure, terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise.

Herein, the terms “about”, “around” and “substantially” typically mean a value is in a range of +/−15% of a stated value, typically a range of +/−10% of the stated value, typically a range of +/−5% of the stated value, typically a range of +/−3% of the stated value, typically a range of +/−2% of the stated value, typically a range of +/−1% of the stated value, or typically a range of +/−0.5% of the stated value.

It should be understood that, although the terms “first”, “second”, “third”, etc. may be used herein to describe various elements, components, regions, layers, portions and/or sections, these elements, components, regions, layers, portions and/or sections should not be limited by these terms. These terms are only used to distinguish one element, component, region, layer, portion or section from another element, component, region, layer, portion or section. Thus, a first element, component, region, layer, portion or section discussed below could be termed a second element, component, region, layer, portion or section without departing from the teachings of the present disclosure.

Unless defined otherwise, all technical and scientific terms used herein have the same meaning as commonly understood by one of ordinary skill in the art to which this disclosure belongs. It should be appreciated that, in each case, the term, which is defined in a commonly used dictionary, should be interpreted as having a meaning that conforms to the relative skills of the present disclosure and the background or the context of the present disclosure, and should not be interpreted in an idealized or overly formal manner unless so defined.

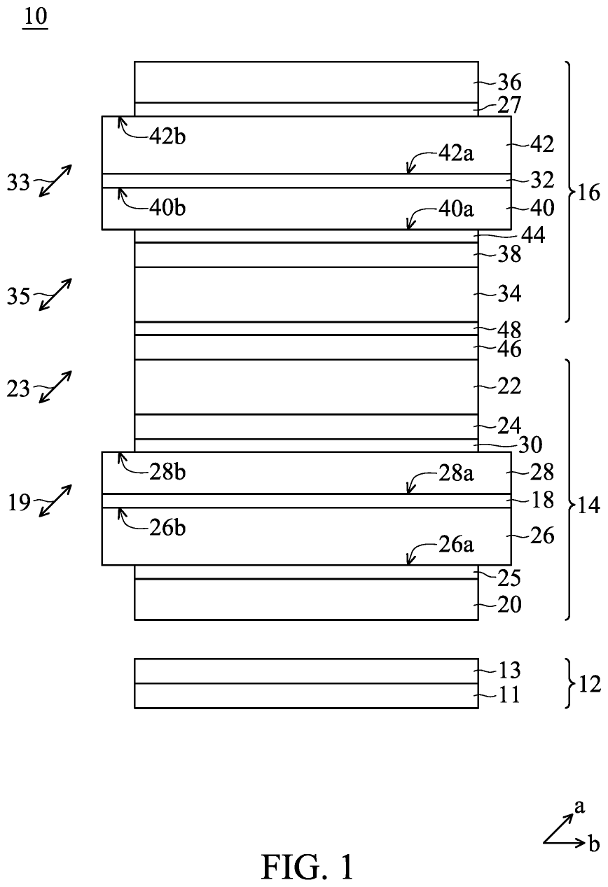

Referring to FIG. 1, in accordance with one embodiment of the present disclosure, an electronic device 10 is provided. FIG. 1 is the cross-sectional view of the electronic device 10.

As shown in FIG. 1, the electronic device 10 includes a backlight module 12, a first liquid-crystal module 14 and a second liquid-crystal module 16. The first liquid-crystal module 14 is disposed on the backlight module 12. The second liquid-crystal module 16 is disposed on the first liquid-crystal module 14.

The backlight module 12 includes a backlight source 11. The backlight source 11 includes, for example, a reflection sheet, a light source, a light-guide plate, a lower diffusion film, a prism sheet (i.e. a light-concentrating sheet) and an upper diffusion film, etc. In FIG. 1, the backlight module 12 further includes a brightness enhancement film (BEF) 13. In some embodiments, the brightness enhancement film 13 includes a reflective dual brightness enhancement film (DBEF) composed of multiple optical films, which is used to recycle light and brings a brighter field of view to viewers, even at a wide viewing angle. The backlight module 12 of the present disclosure may be, for example, a global dimming mode, that is, all backlight sources are turned on and off at the same time, or a local dimming mode, that is, the backlight sources are turned on, turned off and dimmed locally.

The first liquid-crystal module 14 includes a first liquid-crystal layer 18, a first polarizer 20, a second polarizer 22 and a first compensation film 24. The first polarizer 20 is adjacent to the backlight module 12 compared to the second polarizer 22. The first liquid-crystal layer 18 is disposed between the first polarizer 20 and the second polarizer 22. The first liquid-crystal layer 18 has a first alignment direction 19. In FIG. 1, the first alignment direction 19 of the first liquid-crystal layer 18 is a first direction a, and the transmission axis 23 of the second polarizer 22 is also the first direction a, wherein the first direction a may be, for example, a vertical direction. Since the first alignment direction 19 of the first liquid-crystal layer 18 is parallel to the transmission axis 23 of the second polarizer 22 (that is, the first alignment direction 19 of the first liquid-crystal layer 18 is perpendicular to the absorption axis (not shown) of the second polarizer 22), and, in the present disclosure, the compensation film is disposed between the polarizer whose transmission-axis direction is parallel to the liquid-crystal alignment direction and the liquid-crystal layer, the first compensation film 24 is disposed between the second polarizer 22 and the first liquid-crystal layer 18.

In the present disclosure, the measurement of the transmission-axis and absorption-axis directions of the polarizer is to place the polarizer to be measured on the polarizer with the known absorption-axis direction, and then the transmission-axis or absorption-axis direction of the polarizer to be measured is obtained by measuring whether the light passes through or is absorbed. In some embodiments, the first polarizer 20 and the second polarizer 22 may be, for example, a polyvinyl alcohol (PVA) film, but the present disclosure is not limited thereto. In some embodiments, the side of the first polarizer 20 facing the first liquid-crystal layer 18 is provided with an adhesive layer 25, and the side of the first compensation film 24 facing the first liquid-crystal layer 18 is provided with an adhesive layer 30, but not limited thereto. The adhesive layer includes pressure sensitive adhesive (PSA). Setting a compensation film between the polarizer whose transmission-axis direction is parallel to the liquid-crystal alignment direction and the liquid-crystal layer improves the wide-viewing-angle characteristics of the display and eliminates light leakage of the display in the dark state. In some embodiments, the first compensation film 24 is a single-layer compensation film, for example, the R0 value (plane retardation) is 270+/−10 nm, and the Rth value (thickness retardation) is 0+/−10 nm, or the R0 value is 195+/−10 nm, and the Rth value is 0+/−10 nm, but the present disclosure is not limited thereto. In some embodiments, the first compensation film 24 is a double-layer compensation film. For example, the double-layer compensation film is composed of a B plate and a C plate, wherein the R0 value of the B plate is 110+/−10 nm, and the Rth value is −110+/−10 nm. The R0 value of the C plate is 0+/−10 nm, and the Rth value is 115+/−10 nm, but the present disclosure is not limited thereto. In some embodiments, the double-layer compensation film is composed of an A plate and a C plate. In some embodiments, the double-layer compensation film is composed of double B plates, but the present disclosure is not limited thereto.

The first liquid-crystal module 14 further includes a first substrate 26 and a second substrate 28, and the first liquid-crystal layer 18 is disposed between the first substrate 26 and the second substrate 28. Specifically, the first polarizer 20 is disposed on one side 26a of the first substrate 26, and the first liquid-crystal layer 18 is disposed on the other side 26b of the first substrate 26 away from the first polarizer 20. The first liquid-crystal layer 18 is disposed on one side 28a of the second substrate 28, and the first compensation film 24 is disposed on the other side 28b of the second substrate 28 away from the first liquid-crystal layer 18. In some embodiments, the first polarizer 20 is bonded to the first substrate 26 through the adhesive layer 25, and the first compensation film 24 is bonded to the second substrate 28 through the adhesive layer 30. In FIG. 1, the first substrate 26 may be, for example, a substrate including a photoresist-type protective layer material (e.g., photo overcoat (POC)), and the second substrate 28 may be, for example, a thin-film transistor (TFT) substrate, but not limited thereto. The second substrate 28 is a thin-film transistor (TFT) substrate, and the position of the second substrate 28 is farther away from the backlight module 12 than the first substrate 26. Therefore, the problem of light leakage occurring on the thin-film transistor (TFT) substrate caused by the increased brightness of the backlight module 12 can be reduced. In addition, the alignment direction of the first liquid-crystal layer 18 is the same as the alignment direction of the alignment layer (not shown) on the first substrate 26 and the alignment direction of the alignment layer (not shown) on the second substrate 28. For example, when the alignment direction of the liquid crystals in the first liquid-crystal layer 18 is the first direction, it means that the alignment directions of the alignment layers on the first substrate 26 and the second substrate 28 are both the first direction. When the alignment direction of the liquid crystals in the first liquid-crystal layer 18 is the second direction, it means that the alignment directions of the alignment layers on the first substrate 26 and the second substrate 28 are both the second direction. In the present disclosure, the first liquid-crystal module 14 may be, for example, a local dimming mode, that is, the brightness and darkness of each region (i.e. each pixel) can be independently controlled, thereby improving the contrast and resolution.

The second liquid-crystal module 16 includes a second liquid-crystal layer 32, a third polarizer 34, a fourth polarizer 36 and a second compensation film 38. The third polarizer 34 is adjacent to the first liquid-crystal module 14 compared to the fourth polarizer 36. The second liquid-crystal layer 32 is disposed between the third polarizer 34 and the fourth polarizer 36. The second liquid-crystal layer 32 has a second alignment direction 33. In FIG. 1, the second alignment direction 33 of the second liquid-crystal layer 32 is a first direction a, and the transmission axis 35 of the third polarizer 34 is also the first direction a, wherein the first direction a may be, for example, a vertical direction. Since the second alignment direction 33 of the second liquid-crystal layer 32 is parallel to the transmission axis 35 of the third polarizer 35, and, in the present disclosure, the compensation film is disposed between the polarizer whose transmission-axis direction is parallel to the liquid-crystal alignment direction and the liquid-crystal layer, the second compensation film 38 is disposed between the third polarizer 34 and the second liquid-crystal layer 32. In the embodiment shown in FIG. 1, the first alignment direction 19 of the first liquid-crystal layer 18 is parallel to the second alignment direction 33 of the second liquid-crystal layer 32.

The third polarizer 34 and the fourth polarizer 36 may be, for example, a polyvinyl alcohol (PVA) film, but not limited thereto. In some embodiments, the side of the second compensation film 38 facing the second liquid-crystal layer 32 is provided with an adhesive layer 44, and the side of the fourth polarizer 36 facing the second liquid-crystal layer 32 is provided with an adhesive layer 27, but not limited thereto. The adhesive layer includes pressure sensitive adhesive (PSA).

The second liquid-crystal module 16 further includes a third substrate 40 and a fourth substrate 42, and the second liquid-crystal layer 32 is disposed between the third substrate 40 and the fourth substrate 42. Specifically, the second compensation film 38 is disposed on one side 40a of the third substrate 40, and the second liquid-crystal layer 32 is disposed on the other side 40b of the third substrate 40 away from the second compensation film 38. The second liquid-crystal layer 32 is disposed on one side 42a of the fourth substrate 42, and the fourth polarizer 36 is disposed on the other side 42b of the fourth substrate 42 away from the second liquid-crystal layer 32. In some embodiments, the second compensation film 38 is bonded to the third substrate 40 through the adhesive layer 44, and the fourth polarizer 36 is bonded to the fourth substrate 42 through the adhesive layer 27. In FIG. 1, the third substrate 40 may be, for example, a thin-film transistor (TFT) substrate, and the fourth substrate 42 may be, for example, a color-filter (CF) substrate. Here, the fourth substrate 42 may, for example, include RGB photoresists. In addition, the alignment direction of the second liquid-crystal layer 32 is the same as the alignment direction of the alignment layer (not shown) on the third substrate 40 and the alignment direction of the alignment layer (not shown) on the fourth substrate 42. For example, when the alignment direction of the liquid crystals in the second liquid-crystal layer 32 is the first direction, it means that the alignment directions of the alignment layers on the third substrate 40 and the fourth substrate 42 are both the first direction. When the alignment direction of the liquid crystals in the second liquid-crystal layer 32 is the second direction, it means that the alignment directions of the alignment layers on the third substrate 40 and the fourth substrate 42 are both the second direction. In the present disclosure, the second liquid-crystal module 16 is used as a display panel.

In FIG. 1, an adhesive layer 46 is further included between the first liquid-crystal module 14 and the second liquid-crystal module 16. In some embodiments, the adhesive layer 46 includes solid optical clear adhesive (OCA) or liquid optical clear resin (OCR), but not limited thereto. In some embodiments, the thickness of the adhesive layer 46 is between 250 um and 1000 um. A scattering layer 48 (i.e. a haze layer) is further included between the first liquid-crystal module 14 and the second liquid-crystal module 16, for example, it is disposed between the adhesive layer 46 and the second liquid-crystal module 16. In some embodiments, the scattering layer 48 includes glue and scattering particles. The scattering layer 48 disposed between the adhesive layer 46 and the second liquid-crystal module 16 can reduce the common moiré phenomenon of dual-cell displays, but the present disclosure is not limited thereto, and other arrangement manners are also applicable to the present disclosure. In some embodiments, the scattering layer 48 is not provided, but the material of the scattering layer 48 (for example, scattering particles) is mixed and evenly distributed in the adhesive layer 46. In some embodiments, the scattering layer 48 is not provided, but the material of the scattering layer 48 (for example, scattering particles) is mixed and evenly distributed in the adhesive layer between the polarizer and the first liquid-crystal layer 18 of the first liquid-crystal module 14. For example, the material of the scattering layer 48 is mixed into the adhesive layer 30 between the second polarizer 22 and the first liquid-crystal layer 18. In some embodiments, the scattering layer 48 is not provided, but the material of the scattering layer 48 (for example, scattering particles) is mixed and uniformly distributed in the adhesive layer between the polarizer and the second liquid-crystal layer 32 of the second liquid-crystal module 16. For example, the material of the scattering layer 48 is mixed into the adhesive layer 44 between the third polarizer 34 and the second liquid-crystal layer 32.

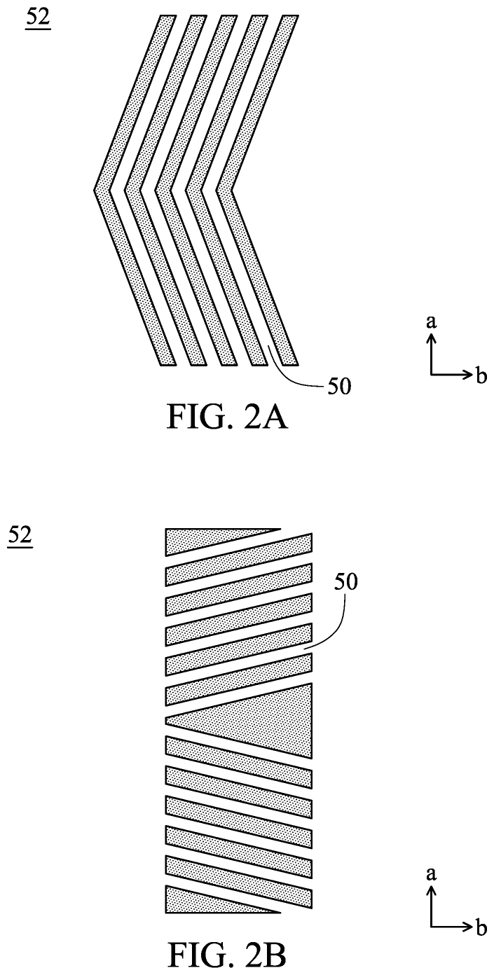

Referring to FIGS. 2A and 2B, in accordance with one embodiment of the present disclosure, the relationships among the pixel patterns (for example, a vertical-chevron shape or a horizontal-chevron shape), the liquid-crystal types (for example, a positive liquid crystal or a negative liquid crystal) and the liquid-crystal alignments (for example, a first direction or a second direction) in the electronic device are described as follows.

In the first liquid-crystal module 14 and the second liquid-crystal module 16, as shown in FIG. 2A, the indium-tin-oxide (ITO) electrode 50 on the thin-film transistor (TFT) substrate is designed in a chevron shape and extends in a first direction a. The first direction a may be, for example, a vertical direction, so that the pixels 52 present a vertical-chevron pattern. At this time, if a positive liquid crystal is selected, the alignment direction of the positive liquid crystal will present the first direction. If a negative liquid crystal is selected, the alignment direction of the negative liquid crystal will present the second direction. Next, as shown in FIG. 2B, the indium-tin-oxide (ITO) electrode 50 on the thin-film transistor (TFT) substrate is designed in a chevron shape and extends in a second direction b. The second direction b may be, for example, a horizontal direction, so that the pixels 52 present a horizontal-chevron pattern. At this time, if a positive liquid crystal is selected, the alignment direction of the positive liquid crystal will present the second direction. If a negative liquid crystal is selected, the alignment direction of the negative liquid crystal will present the first direction.

In the present disclosure, the alignment direction of the liquid crystal is related to the position of the compensation film. For example, in the embodiment shown in FIG. 1, the pixel pattern of the first liquid-crystal module 14 is the vertical-chevron shape, and the first liquid-crystal layer 18 is matched with the positive liquid crystal, so that the alignment direction of the positive liquid crystal in the first liquid-crystal layer 18 presents the first direction. Since the alignment direction of the first liquid-crystal layer 18 is parallel to the transmission axis 23 of the second polarizer 22, the first compensation film 24 is disposed between the second polarizer 22 and the first liquid-crystal layer 18. In addition, the pixel pattern of the second liquid-crystal module 16 is the vertical-chevron shape, and the second liquid-crystal layer 32 is matched with the positive liquid crystal, so that the alignment direction of the positive liquid crystal in the second liquid-crystal layer 32 presents the first direction. Since the alignment direction of the second liquid-crystal layer 32 is parallel to the transmission axis 35 of the third polarizer 34, the second compensation film 38 is disposed between the third polarizer 34 and the second liquid-crystal layer 32.

In the present disclosure, the same liquid-crystal alignment (that is, the same position of the compensation film) is obtained by combining different pixel patterns (for example, a vertical-chevron shape or a horizontal-chevron shape) or different liquid-crystal types (for example, a positive liquid crystal or a negative liquid crystal). Next, the embodiment shown in FIG. 1 is taken as an example for illustration. In FIG. 1, the positions of the two compensation films are respectively that the first compensation film 24 is disposed between the second polarizer 22 and the first liquid-crystal layer 18, and the second compensation film 38 is disposed between the third polarizer 34 and the second liquid-crystal layer 32.

In some embodiments, the pixel pattern of the first liquid-crystal module 14 is the vertical-chevron shape, and the first liquid-crystal layer 18 is matched with the positive liquid crystal, so that the alignment direction of the positive liquid-crystal in the first liquid-crystal layer 18 presents the first direction. In addition, the pixel pattern of the second liquid-crystal module 16 is the horizontal-chevron shape, and the second liquid-crystal layer 32 is matched with the negative liquid crystal, so that the alignment direction of the negative liquid crystal in the second liquid-crystal layer 32 presents the first direction. In the above embodiment, the positions of the two compensation films are the same as those in FIG. 1.

In some embodiments, the pixel pattern of the first liquid-crystal module 14 is the horizontal-chevron shape, and the first liquid-crystal layer 18 is matched with the negative liquid crystal, so that the alignment direction of the negative liquid-crystal in the first liquid-crystal layer 18 presents the first direction. In addition, the pixel pattern of the second liquid-crystal module 16 is the vertical-chevron shape, and the second liquid-crystal layer 32 is matched with the positive liquid crystal, so that the alignment direction of the positive liquid crystal in the second liquid-crystal layer 32 presents the first direction. In the above embodiment, the positions of the two compensation films are the same as those in FIG. 1.

In some embodiments, the pixel pattern of the first liquid-crystal module 14 is the horizontal-chevron shape, and the first liquid-crystal layer 18 is matched with the negative liquid crystal, so that the alignment direction of the negative liquid-crystal in the first liquid-crystal layer 18 presents the first direction. In addition, the pixel pattern of the second liquid-crystal module 16 is the horizontal-chevron shape, and the second liquid-crystal layer 32 is matched with the negative liquid crystal, so that the alignment direction of the negative liquid crystal in the second liquid-crystal layer 32 presents the first direction. In the above embodiment, the positions of the two compensation films are the same as those in FIG. 1.

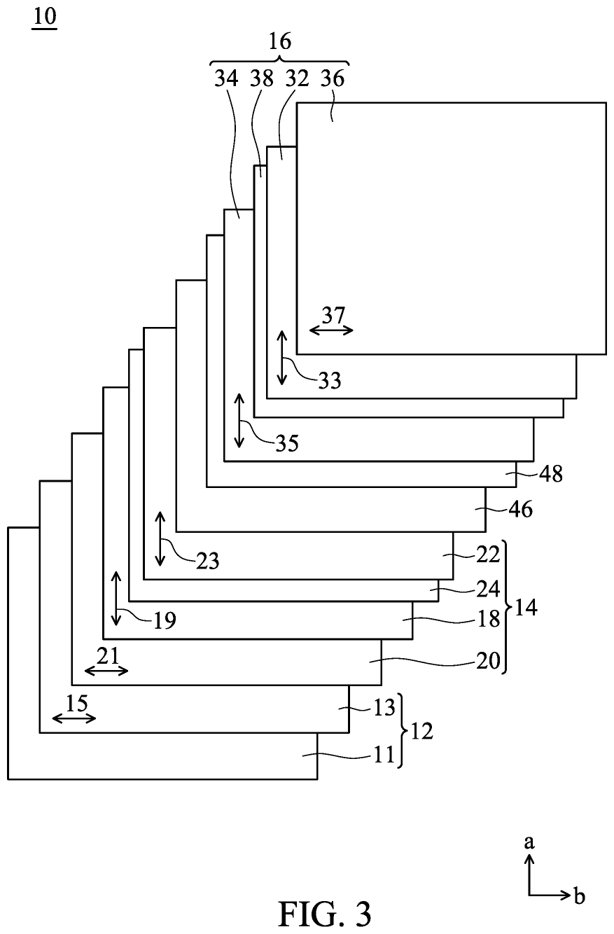

Referring to FIG. 3, which is a layer-by-layer stack diagram of the electronic device 10 shown in FIG. 1, to illustrate the optical-axis configuration of each component in the electronic device 10.

As shown in FIG. 3, the electronic device 10 includes a backlight module (BLM) 12, a first liquid-crystal module 14 and a second liquid-crystal module 16 from bottom to top. The backlight module 12 includes a backlight source 11 and a brightness enhancement film 13 from bottom to top. The first liquid-crystal module 14 includes a first polarizer 20, a first liquid-crystal layer 18, a first compensation film 24 and a second polarizer 22 from bottom to top. The second liquid-crystal module 16 includes a third polarizer 34, a second compensation film 38, a second liquid-crystal layer 32 and a fourth polarizer 36 from bottom to top. In addition, an adhesive layer 46 is further disposed between the first liquid-crystal module 14 and the second liquid-crystal module 16. A scattering layer 48 is further disposed between the adhesive layer 46 and the second liquid-crystal module 16.

The optical axes of the components in the electronic device 10 are configured as follows. The transmission axis 15 of the brightness enhancement film 13 is the second direction b. The transmission axis 21 of the first polarizer 20 is the second direction b. The transmission axis 23 of the second polarizer 22 is the first direction a. The transmission axis 35 of the third polarizer 34 is the first direction a. The transmission axis 37 of the fourth polarizer 36 is the second direction b. The first direction a may be, for example, a vertical direction. The second direction b may be, for example, a horizontal direction. In the embodiment, the transmission axis 15 of the brightness enhancement film 13 is parallel to the transmission axis 21 of the first polarizer 20. The transmission axis 21 of the first polarizer 20 is perpendicular to the transmission axis 23 of the second polarizer 22. The transmission axis 23 of the second polarizer 22 is parallel to the transmission axis 35 of the third polarizer 34. The transmission axis 35 of the third polarizer 34 is perpendicular to the transmission axis 37 of the fourth polarizer 36. In addition, the first alignment direction 19 of the first liquid-crystal layer 18 is the first direction a. The second alignment direction 33 of the second liquid-crystal layer 32 is the first direction a. Therefore, the first alignment direction 19 of the first liquid-crystal layer 18 is parallel to the second alignment direction 33 of the second liquid-crystal layer 32. In accordance with the configuration of the optical axes among the above-mentioned components, the optimal optical axis of the light emitted by the electronic device 10 falls on the horizontal axis, and the horizontal axis has the widest viewing angle and optimal brightness.

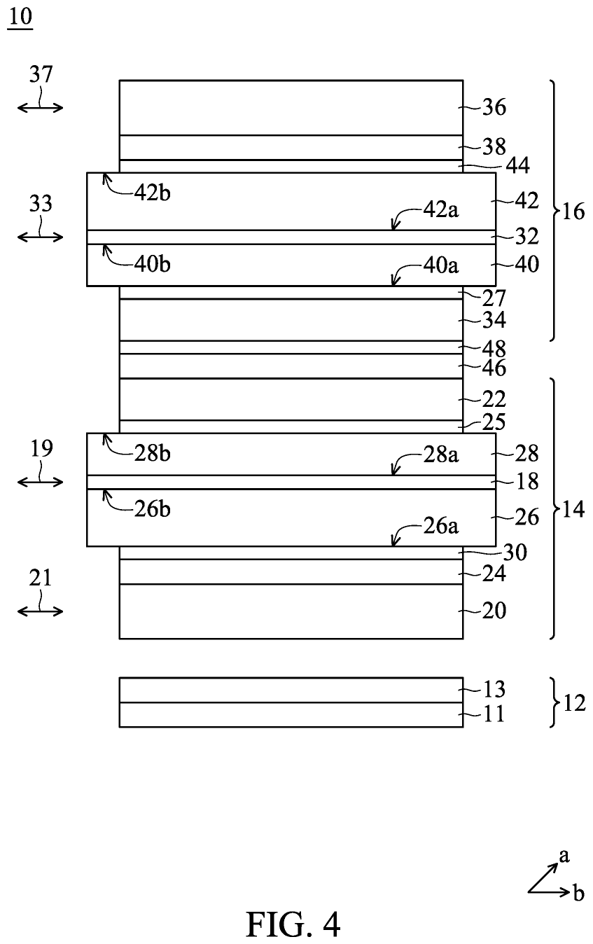

Referring to FIG. 4, in accordance with one embodiment of the present disclosure, an electronic device 10 is provided. FIG. 4 is the cross-sectional view of the electronic device 10.

The embodiment of the electronic device 10 shown in FIG. 4 is similar to the embodiment of the electronic device 10 shown in FIG. 1, and the main difference therebetween lies in the first alignment direction, the second alignment direction and the positions of the first compensation film and the second compensation film.

In FIG. 4, the first alignment direction 19 of the first liquid-crystal layer 18 is the second direction b, and the transmission axis 21 of the first polarizer 20 is also the second direction b, wherein the second direction b may be, for example, a horizontal direction. Since the first alignment direction 19 of the first liquid-crystal layer 18 is parallel to the transmission axis 21 of the first polarizer 20 (that is, the first alignment direction 19 of the first liquid-crystal layer 18 is perpendicular to the absorption axis (not shown) of the first polarizer 20), and, in the present disclosure, the compensation film is disposed between the polarizer whose transmission-axis direction is parallel to the liquid-crystal alignment direction and the liquid-crystal layer, the first compensation film 24 is disposed between the first polarizer 20 and the first liquid-crystal layer 18.

In the first liquid-crystal module 14, the first compensation film 24 is disposed on one side 26a of the first substrate 26. The first liquid-crystal layer 18 is disposed on the other side 26b of the first substrate 26 away from the first compensation film 24. The first liquid-crystal layer 18 is disposed on one side 28a of the second substrate 28. The second polarizer 22 is disposed on the other side 28b of the second substrate 28 away from the first liquid-crystal layer 18. In some embodiments, the first compensation film 24 is bonded to the first substrate 26 through the adhesive layer 30. The second polarizer 22 is bonded to the second substrate 28 through the adhesive layer 25.

In FIG. 4, the second alignment direction 33 of the second liquid-crystal layer 32 is the second direction b, and the transmission axis 37 of the fourth polarizer 36 is also the second direction b, wherein the second direction b may be, for example, a horizontal direction. Since the second alignment direction 33 of the second liquid-crystal layer 32 is parallel to the transmission axis 37 of the fourth polarizer 36, and, in the present disclosure, the compensation film is disposed between the polarizer whose transmission-axis direction is parallel to the liquid-crystal alignment direction and the liquid-crystal layer, the second compensation film 38 is disposed between the fourth polarizer 36 and the second liquid-crystal layer 32. In the embodiment shown in FIG. 4, the first alignment direction 19 of the first liquid-crystal layer 18 is parallel to the second alignment direction 33 of the second liquid-crystal layer 32.

In the second liquid-crystal module 16, the third polarizer 34 is disposed on one side 40a of the third substrate 40. The second liquid-crystal layer 32 is disposed on the other side 40b of the third substrate 40 away from the third polarizer 34. The second liquid-crystal layer 32 is disposed on one side 42a of the fourth substrate 42. The second compensation film 38 is disposed on the other side 42b of the fourth substrate 42 away from the second liquid-crystal layer 32. In some embodiments, the third polarizer 34 is bonded to the third substrate 40 through the adhesive layer 27. The second compensation film 38 is bonded to the fourth substrate 42 through the adhesive layer 44.

In FIG. 4, a scattering layer 48 (i.e. a haze layer, whose composition is similar to that of the scattering layer 48 shown in FIG. 1) is further disposed between the adhesive layer 46 and the second liquid crystal-module 16, but the present disclosure is not limited thereto, and other arrangement manners are also applicable to the present disclosure. In some embodiments, the scattering layer 48 is not provided, but the material of the scattering layer 48 (for example, scattering particles) is mixed and evenly distributed in the adhesive layer 46. In some embodiments, the scattering layer 48 is not provided, but the material of the scattering layer 48 (for example, scattering particles) is mixed and evenly distributed in the adhesive layer between the polarizer and the first liquid-crystal layer 18 of the first liquid-crystal module 14. For example, the material of the scattering layer 48 is mixed into the adhesive layer 25 between the second polarizer 22 and the first liquid-crystal layer 18. In some embodiments, the scattering layer 48 is not provided, but the material of the scattering layer 48 (for example, scattering particles) is mixed and uniformly distributed in the adhesive layer between the polarizer and the second liquid-crystal layer 32 of the second liquid-crystal module 16. For example, the material of the scattering layer 48 is mixed into the adhesive layer 27 between the third polarizer 34 and the second liquid-crystal layer 32.

In the embodiment shown in FIG. 4, the pixel pattern of the first liquid-crystal module 14 is the vertical-chevron shape, and the first liquid-crystal layer 18 is matched with the negative liquid crystal, so that the alignment direction of the negative liquid crystal in the first liquid-crystal layer 18 presents the second direction. Since the alignment direction of the first liquid-crystal layer 18 is parallel to the transmission axis 21 of the first polarizer 20, the first compensation film 24 is disposed between the first polarizer 20 and the first liquid-crystal layer 18. In addition, the pixel pattern of the second liquid-crystal module 16 is the vertical-chevron shape, and the second liquid-crystal layer 32 is matched with the negative liquid crystal, so that the alignment direction of the negative liquid crystal in the second liquid-crystal layer 32 presents the second direction. Since the alignment direction of the second liquid-crystal layer 32 is parallel to the transmission axis 37 of the fourth polarizer 36, the second compensation film 38 is disposed between the fourth polarizer 36 and the second liquid-crystal layer 32.

In the present disclosure, the same liquid-crystal alignment (that is, the same position of the compensation film) is obtained by combining different pixel patterns (for example, a vertical-chevron shape or a horizontal-chevron shape) or different liquid-crystal types (for example, a positive liquid crystal or a negative liquid crystal). Next, the embodiment shown in FIG. 4 is taken as an example for illustration. In FIG. 4, the positions of the two compensation films are respectively that the first compensation film 24 is disposed between the first polarizer 20 and the first liquid-crystal layer 18, and the second compensation film 38 is disposed between the fourth polarizer 36 and the second liquid-crystal layer 32.

In some embodiments, the pixel pattern of the first liquid-crystal module 14 is the vertical-chevron shape, and the first liquid-crystal layer 18 is matched with the negative liquid crystal, so that the alignment direction of the negative liquid-crystal in the first liquid-crystal layer 18 presents the second direction. In addition, the pixel pattern of the second liquid-crystal module 16 is the horizontal-chevron shape, and the second liquid-crystal layer 32 is matched with the positive liquid crystal, so that the alignment direction of the positive liquid crystal in the second liquid-crystal layer 32 presents the second direction. In the above embodiment, the positions of the two compensation films are the same as those in FIG. 4.

In some embodiments, the pixel pattern of the first liquid-crystal module 14 is the horizontal-chevron shape, and the first liquid-crystal layer 18 is matched with the positive liquid crystal, so that the alignment direction of the positive liquid-crystal in the first liquid-crystal layer 18 presents the second direction. In addition, the pixel pattern of the second liquid-crystal module 16 is the vertical-chevron shape, and the second liquid-crystal layer 32 is matched with the negative liquid crystal, so that the alignment direction of the negative liquid crystal in the second liquid-crystal layer 32 presents the second direction. In the above embodiment, the positions of the two compensation films are the same as those in FIG. 4.

In some embodiments, the pixel pattern of the first liquid-crystal module 14 is the horizontal-chevron shape, and the first liquid-crystal layer 18 is matched with the positive liquid crystal, so that the alignment direction of the positive liquid-crystal in the first liquid-crystal layer 18 presents the second direction. In addition, the pixel pattern of the second liquid-crystal module 16 is the horizontal-chevron shape, and the second liquid-crystal layer 32 is matched with the positive liquid crystal, so that the alignment direction of the positive liquid crystal in the second liquid-crystal layer 32 presents the second direction. In the above embodiment, the positions of the two compensation films are the same as those in FIG. 4.

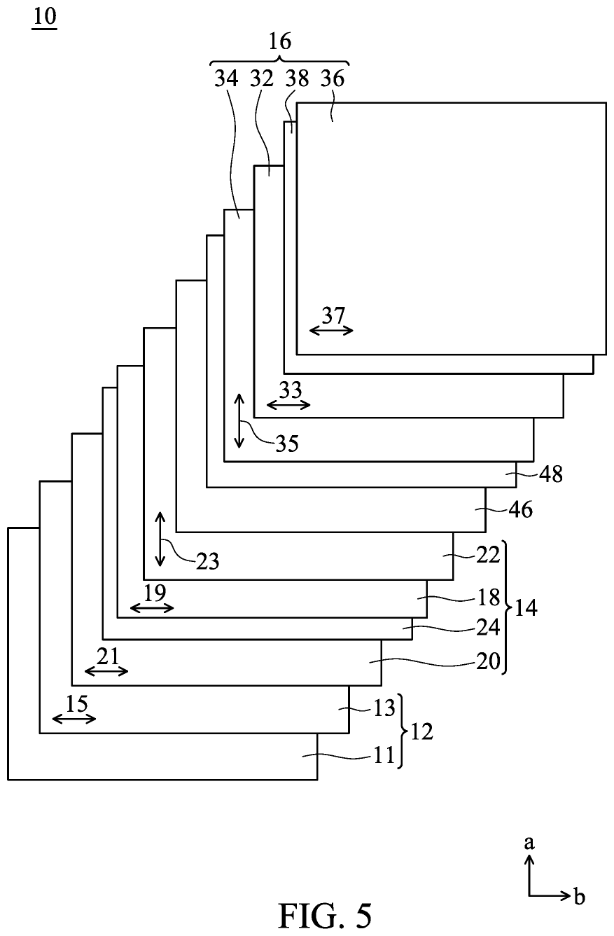

Referring to FIG. 5, which is a layer-by-layer stack diagram of the electronic device 10 shown in FIG. 4, to illustrate the optical-axis configuration of each component in the electronic device 10.

As shown in FIG. 5, the electronic device 10 includes a backlight module (BLM) 12, a first liquid-crystal module 14 and a second liquid-crystal module 16 from bottom to top. The backlight module 12 includes a backlight source 11 and a brightness enhancement film 13 from bottom to top. The first liquid-crystal module 14 includes a first polarizer 20, a first compensation film 24, a first liquid-crystal layer 18 and a second polarizer 22 from bottom to top. The second liquid-crystal module 16 includes a third polarizer 34, a second liquid-crystal layer 32, a second compensation film 38 and a fourth polarizer 36 from bottom to top. In addition, an adhesive layer 46 is further disposed between the first liquid-crystal module 14 and the second liquid-crystal module 16. A scattering layer 48 is further disposed between the adhesive layer 46 and the second liquid-crystal module 16.

The optical-axis configuration of each component in the electronic device 10 shown in FIG. 5 is similar to the optical-axis configuration of each component in the electronic device 10 shown in FIG. 3, and will not be repeated here. In addition, the first alignment direction 19 of the first liquid-crystal layer 18 is the second direction b. The second alignment direction 33 of the second liquid-crystal layer 32 is the second direction b. Therefore, the first alignment direction 19 of the first liquid-crystal layer 18 is parallel to the second alignment direction 33 of the second liquid-crystal layer 32. In accordance with the configuration of the optical axes among the above-mentioned components, the optimal optical axis of the light emitted by the electronic device 10 falls on the horizontal axis, and the horizontal axis has the widest viewing angle and optimal brightness.

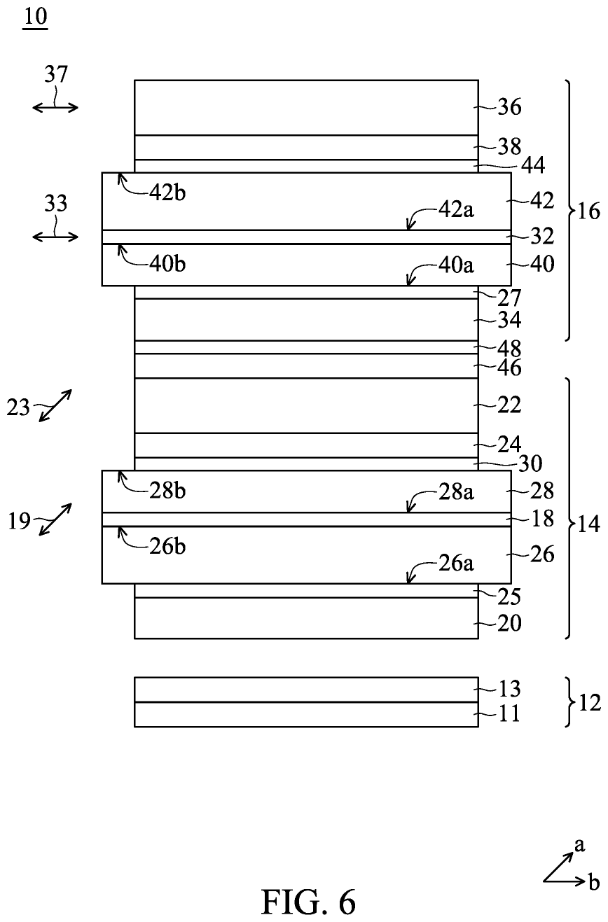

Referring to FIG. 6, in accordance with one embodiment of the present disclosure, an electronic device 10 is provided. FIG. 6 is the cross-sectional view of the electronic device 10.

The embodiment of the electronic device 10 shown in FIG. 6 is similar to the embodiment of the electronic device 10 shown in FIG. 1, and the main difference therebetween lies in the second alignment direction and the position of the second compensation film.

In FIG. 6, the first alignment direction 19 of the first liquid-crystal layer 18 is the first direction a, and the transmission axis 23 of the second polarizer 22 is also the first direction a. Since the first alignment direction 19 of the first liquid-crystal layer 18 is parallel to the transmission axis 23 of the second polarizer 22 (that is, the first alignment direction 19 of the first liquid-crystal layer 18 is perpendicular to the absorption axis (not shown) of the second polarizer 22), and, in the present disclosure, the compensation film is disposed between the polarizer whose transmission-axis direction is parallel to the liquid-crystal alignment direction and the liquid-crystal layer, the first compensation film 24 is disposed between the second polarizer 22 and the first liquid-crystal layer 18.

In the first liquid-crystal module 14, the first polarizer 20 is disposed on one side 26a of the first substrate 26. The first liquid-crystal layer 18 is disposed on the other side 26b of the first substrate 26 away from the first polarizer 20. The first liquid-crystal layer 18 is disposed on one side 28a of the second substrate 28. The first compensation film 24 is disposed on the other side 28b of the second substrate 28 away from the first liquid-crystal layer 18. In some embodiments, the first polarizer 20 is bonded to the first substrate 26 through the adhesive layer 25. The first compensation film 24 is bonded to the second substrate 28 through the adhesive layer 30.

In FIG. 6, the second alignment direction 33 of the second liquid-crystal layer 32 is the second direction b, and the transmission axis 37 of the fourth polarizer 36 is also the second direction b, wherein the second direction b may be, for example, a horizontal direction. Since the second alignment direction 33 of the second liquid-crystal layer 32 is parallel to the transmission axis 37 of the fourth polarizer 36, and, in the present disclosure, the compensation film is disposed between the polarizer whose transmission-axis direction is parallel to the liquid-crystal alignment direction and the liquid-crystal layer, the second compensation film 38 is disposed between the fourth polarizer 36 and the second liquid-crystal layer 32. In the embodiment shown in FIG. 6, the first alignment direction 19 of the first liquid-crystal layer 18 is not parallel (i.e. perpendicular) to the second alignment direction 33 of the second liquid-crystal layer 32.

In the second liquid-crystal module 16, the third polarizer 34 is disposed on one side 40a of the third substrate 40. The second liquid-crystal layer 32 is disposed on the other side 40b of the third substrate 40 away from the third polarizer 34. The second liquid-crystal layer 32 is disposed on one side 42a of the fourth substrate 42. The second compensation film 38 is disposed on the other side 42b of the fourth substrate 42 away from the second liquid-crystal layer 32. In some embodiments, the third polarizer 34 is bonded to the third substrate 40 through the adhesive layer 27. The second compensation film 38 is bonded to the fourth substrate 42 through the adhesive layer 44.

In FIG. 6, a scattering layer 48 (i.e. a haze layer, whose composition is similar to that of the scattering layer 48 shown in FIG. 1) is further disposed between the adhesive layer 46 and the second liquid crystal-module 16, but the present disclosure is not limited thereto, and other arrangement manners are also applicable to the present disclosure. In some embodiments, the scattering layer 48 is not provided, but the material of the scattering layer 48 (for example, scattering particles) is mixed and evenly distributed in the adhesive layer 46. In some embodiments, the scattering layer 48 is not provided, but the material of the scattering layer 48 (for example, scattering particles) is mixed and evenly distributed in the adhesive layer between the polarizer and the first liquid-crystal layer 18 of the first liquid-crystal module 14. For example, the material of the scattering layer 48 is mixed into the adhesive layer 30 between the second polarizer 22 and the first liquid-crystal layer 18. In some embodiments, the scattering layer 48 is not provided, but the material of the scattering layer 48 (for example, scattering particles) is mixed and uniformly distributed in the adhesive layer between the polarizer and the second liquid-crystal layer 32 of the second liquid-crystal module 16. For example, the material of the scattering layer 48 is mixed into the adhesive layer 27 between the third polarizer 34 and the second liquid-crystal layer 32.

In the embodiment shown in FIG. 6, the pixel pattern of the first liquid-crystal module 14 is the horizontal-chevron shape, and the first liquid-crystal layer 18 is matched with the negative liquid crystal, so that the alignment direction of the negative liquid crystal in the first liquid-crystal layer 18 presents the first direction. Since the alignment direction of the first liquid-crystal layer 18 is parallel to the transmission axis 23 of the second polarizer 22, the first compensation film 24 is disposed between the second polarizer 22 and the first liquid-crystal layer 18. In addition, the pixel pattern of the second liquid-crystal module 16 is the vertical-chevron shape, and the second liquid-crystal layer 32 is matched with the negative liquid crystal, so that the alignment direction of the negative liquid crystal in the second liquid-crystal layer 32 presents the second direction. Since the alignment direction of the second liquid-crystal layer 32 is parallel to the transmission axis 37 of the fourth polarizer 36, the second compensation film 38 is disposed between the fourth polarizer 36 and the second liquid-crystal layer 32.

In the present disclosure, the same liquid-crystal alignment (that is, the same position of the compensation film) is obtained by combining different pixel patterns (for example, a vertical-chevron shape or a horizontal-chevron shape) or different liquid-crystal types (for example, a positive liquid crystal or a negative liquid crystal). Next, the embodiment shown in FIG. 6 is taken as an example for illustration. In FIG. 6, the positions of the two compensation films are respectively that the first compensation film 24 is disposed between the second polarizer 22 and the first liquid-crystal layer 18, and the second compensation film 38 is disposed between the fourth polarizer 36 and the second liquid-crystal layer 32.

In some embodiments, the pixel pattern of the first liquid-crystal module 14 is the vertical-chevron shape, and the first liquid-crystal layer 18 is matched with the positive liquid crystal, so that the alignment direction of the positive liquid-crystal in the first liquid-crystal layer 18 presents the first direction. In addition, the pixel pattern of the second liquid-crystal module 16 is the horizontal-chevron shape, and the second liquid-crystal layer 32 is matched with the positive liquid crystal, so that the alignment direction of the positive liquid crystal in the second liquid-crystal layer 32 presents the second direction. In the above embodiment, the positions of the two compensation films are the same as those in FIG. 6.

In some embodiments, the pixel pattern of the first liquid-crystal module 14 is the vertical-chevron shape, and the first liquid-crystal layer 18 is matched with the positive liquid crystal, so that the alignment direction of the positive liquid-crystal in the first liquid-crystal layer 18 presents the first direction. In addition, the pixel pattern of the second liquid-crystal module 16 is the vertical-chevron shape, and the second liquid-crystal layer 32 is matched with the negative liquid crystal, so that the alignment direction of the negative liquid crystal in the second liquid-crystal layer 32 presents the second direction. In the above embodiment, the positions of the two compensation films are the same as those in FIG. 6.

In some embodiments, the pixel pattern of the first liquid-crystal module 14 is the horizontal-chevron shape, and the first liquid-crystal layer 18 is matched with the negative liquid crystal, so that the alignment direction of the negative liquid-crystal in the first liquid-crystal layer 18 presents the first direction. In addition, the pixel pattern of the second liquid-crystal module 16 is the horizontal-chevron shape, and the second liquid-crystal layer 32 is matched with the positive liquid crystal, so that the alignment direction of the positive liquid crystal in the second liquid-crystal layer 32 presents the second direction. In the above embodiment, the positions of the two compensation films are the same as those in FIG. 6.

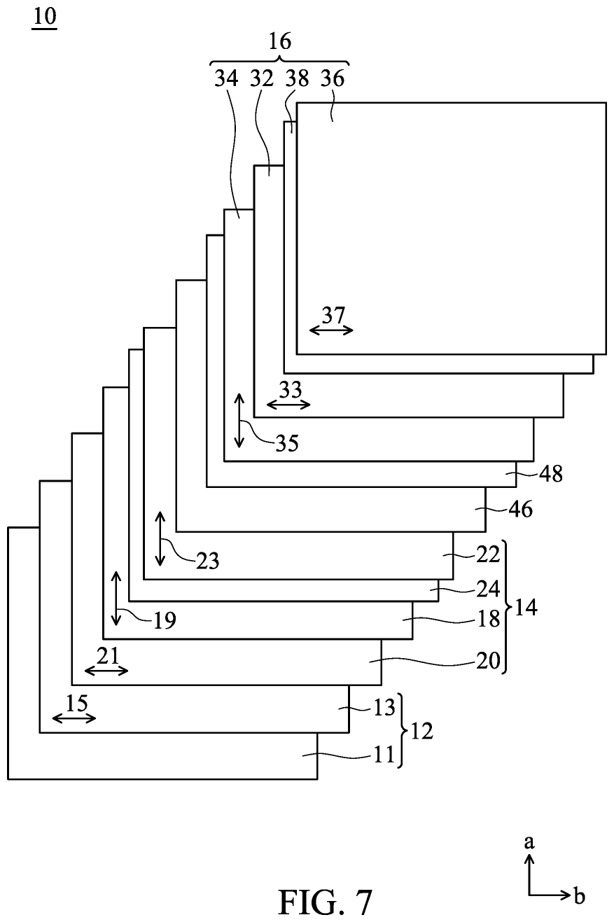

Referring to FIG. 7, which is a layer-by-layer stack diagram of the electronic device 10 shown in FIG. 6, to illustrate the optical-axis configuration of each component in the electronic device 10.

As shown in FIG. 7, the electronic device 10 includes a backlight module (BLM) 12, a first liquid-crystal module 14 and a second liquid-crystal module 16 from bottom to top. The backlight module 12 includes a backlight source 11 and a brightness enhancement film 13 from bottom to top. The first liquid-crystal module 14 includes a first polarizer 20, a first liquid-crystal layer 18, a first compensation film 24 and a second polarizer 22 from bottom to top. The second liquid-crystal module 16 includes a third polarizer 34, a second liquid-crystal layer 32, a second compensation film 38 and a fourth polarizer 36 from bottom to top. In addition, an adhesive layer 46 is further disposed between the first liquid-crystal module 14 and the second liquid-crystal module 16. A scattering layer 48 is further disposed between the adhesive layer 46 and the second liquid-crystal module 16.

The optical-axis configuration of each component in the electronic device 10 shown in FIG. 7 is similar to the optical-axis configuration of each component in the electronic device 10 shown in FIG. 3, and will not be repeated here. In addition, the first alignment direction 19 of the first liquid-crystal layer 18 is the first direction a. The second alignment direction 33 of the second liquid-crystal layer 32 is the second direction b. Therefore, the first alignment direction 19 of the first liquid-crystal layer 18 is not parallel (i.e. perpendicular) to the second alignment direction 33 of the second liquid-crystal layer 32.

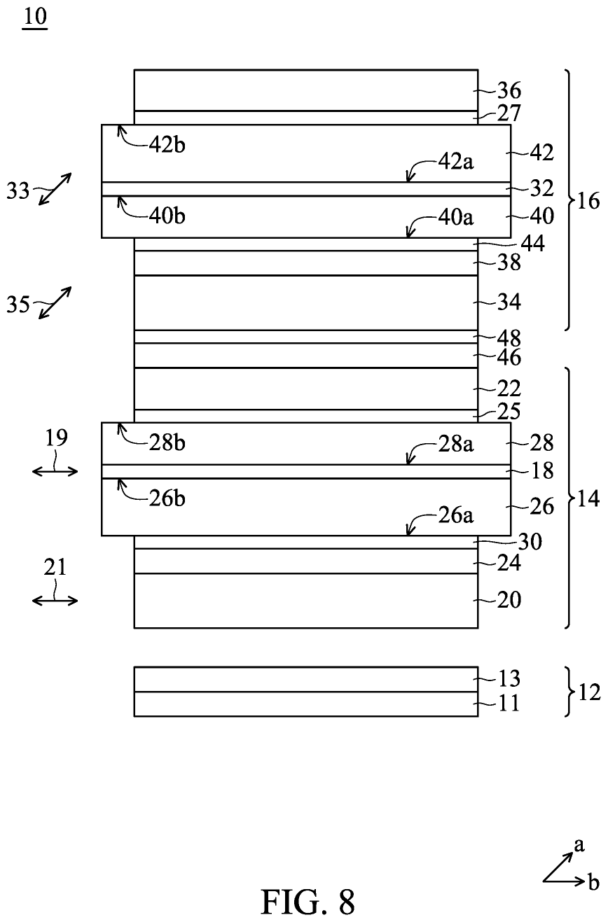

Referring to FIG. 8, in accordance with one embodiment of the present disclosure, an electronic device 10 is provided. FIG. 8 is the cross-sectional view of the electronic device 10.

The embodiment of the electronic device 10 shown in FIG. 8 is similar to the embodiment of the electronic device 10 shown in FIG. 1, and the main difference therebetween lies in the first alignment direction and the position of the first compensation film.

In FIG. 8, the first alignment direction 19 of the first liquid-crystal layer 18 is the second direction b, and the transmission axis 21 of the first polarizer 20 is also the second direction b. Since the first alignment direction 19 of the first liquid-crystal layer 18 is parallel to the transmission axis 21 of the first polarizer 20 (that is, the first alignment direction 19 of the first liquid-crystal layer 18 is perpendicular to the absorption axis (not shown) of the first polarizer 20), and, in the present disclosure, the compensation film is disposed between the polarizer whose transmission-axis direction is parallel to the liquid-crystal alignment direction and the liquid-crystal layer, the first compensation film 24 is disposed between the first polarizer 20 and the first liquid-crystal layer 18.

In the first liquid-crystal module 14, the first compensation film 24 is disposed on one side 26a of the first substrate 26. The first liquid-crystal layer 18 is disposed on the other side 26b of the first substrate 26 away from the first compensation film 24. The first liquid-crystal layer 18 is disposed on one side 28a of the second substrate 28. The second polarizer 22 is disposed on the other side 28b of the second substrate 28 away from the first liquid-crystal layer 18. In some embodiments, the first compensation film 24 is bonded to the first substrate 26 through the adhesive layer 30. The second polarizer 22 is bonded to the second substrate 28 through the adhesive layer 25.

In FIG. 8, the second alignment direction 33 of the second liquid-crystal layer 32 is the first direction a, and the transmission axis 35 of the third polarizer 34 is also the first direction a. Since the second alignment direction 33 of the second liquid-crystal layer 32 is parallel to the transmission axis 35 of the third polarizer 34, and, in the present disclosure, the compensation film is disposed between the polarizer whose transmission-axis direction is parallel to the liquid-crystal alignment direction and the liquid-crystal layer, the second compensation film 38 is disposed between the third polarizer 34 and the second liquid-crystal layer 32. In the embodiment shown in FIG. 8, the first alignment direction 19 of the first liquid-crystal layer 18 is not parallel (i.e. perpendicular) to the second alignment direction 33 of the second liquid-crystal layer 32.

In the second liquid-crystal module 16, the second compensation film 38 is disposed on one side 40a of the third substrate 40. The second liquid-crystal layer 32 is disposed on the other side 40b of the third substrate 40 away from the second compensation film 38. The second liquid-crystal layer 32 is disposed on one side 42a of the fourth substrate 42. The fourth polarizer 36 is disposed on the other side 42b of the fourth substrate 42 away from the second liquid-crystal layer 32. In some embodiments, the second compensation film 38 is bonded to the third substrate 40 through the adhesive layer 44. The fourth polarizer 36 is bonded to the fourth substrate 42 through the adhesive layer 27.

In FIG. 8, a scattering layer 48 (i.e. a haze layer, whose composition is similar to that of the scattering layer 48 shown in FIG. 1) is further disposed between the adhesive layer 46 and the second liquid crystal-module 16, but the present disclosure is not limited thereto, and other arrangement manners are also applicable to the present disclosure. In some embodiments, the scattering layer 48 is not provided, but the material of the scattering layer 48 (for example, scattering particles) is mixed and evenly distributed in the adhesive layer 46. In some embodiments, the scattering layer 48 is not provided, but the material of the scattering layer 48 (for example, scattering particles) is mixed and evenly distributed in the adhesive layer between the polarizer and the first liquid-crystal layer 18 of the first liquid-crystal module 14. For example, the material of the scattering layer 48 is mixed into the adhesive layer 25 between the second polarizer 22 and the first liquid-crystal layer 18. In some embodiments, the scattering layer 48 is not provided, but the material of the scattering layer 48 (for example, scattering particles) is mixed and uniformly distributed in the adhesive layer between the polarizer and the second liquid-crystal layer 32 of the second liquid-crystal module 16. For example, the material of the scattering layer 48 is mixed into the adhesive layer 44 between the third polarizer 34 and the second liquid-crystal layer 32.

In the embodiment shown in FIG. 8, the pixel pattern of the first liquid-crystal module 14 is the horizontal-chevron shape, and the first liquid-crystal layer 18 is matched with the positive liquid crystal, so that the alignment direction of the positive liquid crystal in the first liquid-crystal layer 18 presents the second direction. Since the alignment direction of the first liquid-crystal layer 18 is parallel to the transmission axis 21 of the first polarizer 20, the first compensation film 24 is disposed between the first polarizer 20 and the first liquid-crystal layer 18. In addition, the pixel pattern of the second liquid-crystal module 16 is the vertical-chevron shape, and the second liquid-crystal layer 32 is matched with the positive liquid crystal, so that the alignment direction of the positive liquid crystal in the second liquid-crystal layer 32 presents the first direction. Since the alignment direction of the second liquid-crystal layer 32 is parallel to the transmission axis 35 of the third polarizer 34, the second compensation film 38 is disposed between the third polarizer 34 and the second liquid-crystal layer 32.

In the present disclosure, the same liquid-crystal alignment (that is, the same position of the compensation film) is obtained by combining different pixel patterns (for example, a vertical-chevron shape or a horizontal-chevron shape) or different liquid-crystal types (for example, a positive liquid crystal or a negative liquid crystal). Next, the embodiment shown in FIG. 8 is taken as an example for illustration. In FIG. 8, the positions of the two compensation films are respectively that the first compensation film 24 is disposed between the first polarizer 20 and the first liquid-crystal layer 18, and the second compensation film 38 is disposed between the third polarizer 34 and the second liquid-crystal layer 32.

In some embodiments, the pixel pattern of the first liquid-crystal module 14 is the vertical-chevron shape, and the first liquid-crystal layer 18 is matched with the negative liquid crystal, so that the alignment direction of the negative liquid-crystal in the first liquid-crystal layer 18 presents the second direction. In addition, the pixel pattern of the second liquid-crystal module 16 is the horizontal-chevron shape, and the second liquid-crystal layer 32 is matched with the negative liquid crystal, so that the alignment direction of the negative liquid crystal in the second liquid-crystal layer 32 presents the first direction. In the above embodiment, the positions of the two compensation films are the same as those in FIG. 8.

In some embodiments, the pixel pattern of the first liquid-crystal module 14 is the vertical-chevron shape, and the first liquid-crystal layer 18 is matched with the negative liquid crystal, so that the alignment direction of the negative liquid-crystal in the first liquid-crystal layer 18 presents the second direction. In addition, the pixel pattern of the second liquid-crystal module 16 is the vertical-chevron shape, and the second liquid-crystal layer 32 is matched with the positive liquid crystal, so that the alignment direction of the positive liquid crystal in the second liquid-crystal layer 32 presents the first direction. In the above embodiment, the positions of the two compensation films are the same as those in FIG. 8.

In some embodiments, the pixel pattern of the first liquid-crystal module 14 is the horizontal-chevron shape, and the first liquid-crystal layer 18 is matched with the positive liquid crystal, so that the alignment direction of the positive liquid-crystal in the first liquid-crystal layer 18 presents the second direction. In addition, the pixel pattern of the second liquid-crystal module 16 is the horizontal-chevron shape, and the second liquid-crystal layer 32 is matched with the negative liquid crystal, so that the alignment direction of the negative liquid crystal in the second liquid-crystal layer 32 presents the first direction. In the above embodiment, the positions of the two compensation films are the same as those in FIG. 8.

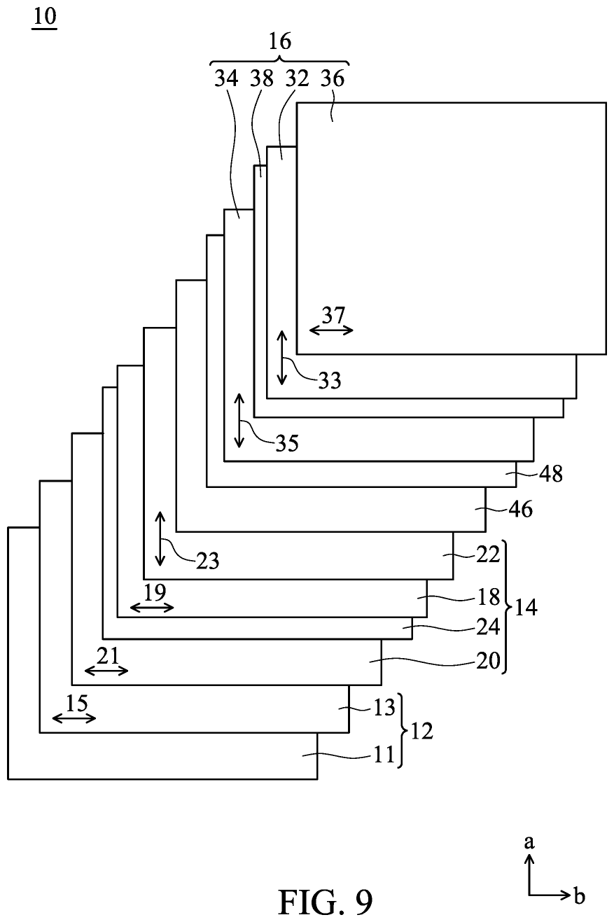

Referring to FIG. 9, which is a layer-by-layer stack diagram of the electronic device 10 shown in FIG. 8, to illustrate the optical-axis configuration of each component in the electronic device 10.

As shown in FIG. 9, the electronic device 10 includes a backlight module (BLM) 12, a first liquid-crystal module 14 and a second liquid-crystal module 16 from bottom to top. The backlight module 12 includes a backlight source 11 and a brightness enhancement film 13 from bottom to top. The first liquid-crystal module 14 includes a first polarizer 20, a first compensation film 24, a first liquid-crystal layer 18 and a second polarizer 22 from bottom to top. The second liquid-crystal module 16 includes a third polarizer 34, a second compensation film 38, a second liquid-crystal layer 32 and a fourth polarizer 36 from bottom to top. In addition, an adhesive layer 46 is further disposed between the first liquid-crystal module 14 and the second liquid-crystal module 16. A scattering layer 48 is further disposed between the adhesive layer 46 and the second liquid-crystal module 16.

The optical-axis configuration of each component in the electronic device 10 shown in FIG. 9 is similar to the optical-axis configuration of each component in the electronic device 10 shown in FIG. 3, and will not be repeated here. In addition, the first alignment direction 19 of the first liquid-crystal layer 18 is the second direction b. The second alignment direction 33 of the second liquid-crystal layer 32 is the first direction a. Therefore, the first alignment direction 19 of the first liquid-crystal layer 18 is not parallel (i.e. perpendicular) to the second alignment direction 33 of the second liquid-crystal layer 32.

In the present disclosure, the first liquid-crystal module in the electronic device is set to a local-dimming mode to independently control the brightness and darkness of each region (pixel) to improve contrast ratio (CR) and resolution. In addition, the desired liquid-crystal alignment is obtained through the combination of different pixel patterns (for example, a vertical-chevron shape or a horizontal-chevron shape) or different liquid-crystal types (for example, a positive liquid crystal or a negative liquid crystal). The compensation film is disposed between the polarizer whose transmission-axis direction is parallel to the liquid-crystal alignment direction and the liquid-crystal layer to improve the wide-viewing-angle characteristics of the display and eliminate light leakage of the display in the dark state. Furthermore, according to the special optical-axis configuration (for example, the transmission axis of the brightness enhancement film is parallel to the transmission axis of the first polarizer, the transmission axis of the first polarizer is perpendicular to the transmission axis of the second polarizer, the transmission axis of the second polarizer is parallel to the transmission axis of the third polarizer, and the transmission axis of the third polarizer is perpendicular to the transmission axis of the fourth polarizer) among the components in the electronic device, that is, according to the optimal optical-axis design among the backlight module, the first liquid-crystal module and the second liquid-crystal module, the optimal optical axis of the light emitted by the electronic device falls on the horizontal axis, and the horizontal axis has the widest viewing angle and optimal brightness. In addition, the scattering layer (i.e. the haze layer) disposed between the OCA or OCR adhesive layer and the second liquid-crystal module reduces the common moiré phenomenon of dual-cell displays. In conclusion, the disclosed electronic device simultaneously meets the high contrast ratio (for example, 1,000,000:1), eliminates the moiré phenomenon, maintains the high penetration, and achieves the wide-viewing-angle requirements that the widest viewing angle and optimal brightness are on the horizontal axis.

Although some embodiments of the present disclosure and their advantages have been described in detail, it should be understood that various changes, substitutions and alterations can be made herein without departing from the spirit and scope of the disclosure as defined by the appended claims. The features of the various embodiments can be used in any combination as long as they do not depart from the spirit and scope of the present disclosure. Moreover, the scope of the present application is not intended to be limited to the particular embodiments of the process, machine, manufacture, composition of matter, means, methods and steps described in the specification. As one of ordinary skill in the art will readily appreciate from the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods or steps. In addition, each claim constitutes an individual embodiment, and the claimed scope of the present disclosure includes the combinations of the claims and embodiments. The scope of protection of present disclosure is subject to the definition of the scope of the appended claims. Any embodiment or claim of the present disclosure does not need to meet all the purposes, advantages, and features disclosed in the present disclosure.

What is claimed is:

1. An electronic device, comprising:
a backlight module;
a first liquid-crystal module disposed on the backlight module and comprising a first liquid-crystal layer, a first polarizer, a second polarizer and a first compensation film, wherein the first polarizer is adjacent to the backlight module compared to the second polarizer, and the first liquid-crystal layer is disposed between the first polarizer and the second polarizer and has a first alignment direction; and
a second liquid-crystal module disposed on the first liquid-crystal module,
wherein the first compensation film is disposed between the first liquid-crystal layer and one of the first polarizer and the second polarizer, and the first alignment direction is parallel to a transmission axis of the one of the first polarizer and the second polarizer.

2. The electronic device as claimed in claim 1, wherein a transmission axis of the first polarizer is perpendicular to a transmission axis of the second polarizer.

3. The electronic device as claimed in claim 1, wherein the backlight module further comprises a brightness enhancement film, and a transmission axis of the brightness enhancement film is parallel to a transmission axis of the first polarizer.

4. The electronic device as claimed in claim 1, wherein the second liquid-crystal module comprises a second liquid-crystal layer, a third polarizer and a fourth polarizer, the third polarizer is adjacent to the first liquid-crystal module compared to the fourth polarizer, and the second liquid-crystal layer is disposed between the third polarizer and the fourth polarizer.

5. The electronic device as claimed in claim 4, wherein the second liquid-crystal module further comprises a second compensation film, and the second liquid-crystal layer has a second alignment direction, wherein the second compensation film is disposed between the second liquid-crystal layer and one of the third polarizer and the fourth polarizer, and the second alignment direction is parallel to a transmission axis of the one of the third polarizer and the fourth polarizer.

6. The electronic device as claimed in claim 5, wherein the first alignment direction is parallel to the second alignment direction.

7. The electronic device as claimed in claim 4, wherein a transmission axis of the second polarizer is parallel to a transmission axis of the third polarizer.

8. The electronic device as claimed in claim 4, further comprising an adhesive layer disposed between the first liquid-crystal module and the second liquid-crystal module.

9. The electronic device as claimed in claim 8, wherein the adhesive layer contains scattering particles.

10. The electronic device as claimed in claim 4, further comprising a scattering layer disposed between the first liquid-crystal module and the second liquid-crystal module.

11. The electronic device as claimed in claim 4, wherein a transmission axis of the third polarizer is perpendicular to a transmission axis of the fourth polarizer.

12. The electronic device as claimed in claim 5, wherein the first compensation film is disposed between the second polarizer and the first liquid-crystal layer, and the second compensation film is disposed between the third polarizer and the second liquid-crystal layer.

13. The electronic device as claimed in claim 12, wherein the first alignment direction is parallel to a transmission axis of the second polarizer, and the second alignment direction is parallel to a transmission axis of the third polarizer.

14. The electronic device as claimed in claim 5, wherein the first compensation film is disposed between the first polarizer and the first liquid-crystal layer, and the second compensation film is disposed between the fourth polarizer and the second liquid-crystal layer.

15. The electronic device as claimed in claim 14, wherein the first alignment direction is parallel to a transmission axis of the first polarizer, and the second alignment direction is parallel to a transmission axis of the fourth polarizer.

16. The electronic device as claimed in claim 5, wherein the first compensation film is disposed between the second polarizer and the first liquid-crystal layer, and the second compensation film is disposed between the fourth polarizer and the second liquid-crystal layer.

17. The electronic device as claimed in claim 16, wherein the first alignment direction is parallel to a transmission axis of the second polarizer, and the second alignment direction is parallel to a transmission axis of the fourth polarizer.

18. The electronic device as claimed in claim 5, wherein the first compensation film is disposed between the first polarizer and the first liquid-crystal layer, and the second compensation film is disposed between the third polarizer and the second liquid-crystal layer.

19. The electronic device as claimed in claim 18, wherein the first alignment direction is parallel to a transmission axis of the first polarizer, and the second alignment direction is parallel to a transmission axis of the third polarizer.

20. The electronic device as claimed in claim 1, wherein the first liquid-crystal module and the second liquid-crystal module further comprise indium-tin-oxide (ITO) electrodes extending in a chevron shape.
